(19) United States
(12) Patent Application Publication
(10) Pub. No.: US 2015/0025659 A1
(43) Pub. Date: Jan. 22, 2015

(54) Home Automation Network

(71) Applicant: GOOGLE INC., Mountain View, CA (US)

(72) Inventors: Scott Bartlett, Oakland, CA (US); Michael Sleator, Woodside, CA (US)

(21) Appl. No.: 13/944,037

(22) Filed: Jul. 17, 2013

(51) Int. Cl. G05B 15/02

(52) U.S. Cl. CPC G05B 15/02
USPC 700/90

(57) ABSTRACT

Systems and techniques are disclosed for implementations of a home automation network. A first input can be received from a first sensor on a home automation network and a second input can be received from a second sensor on the network. A condition can be determined based on both inputs that could not be determined from either input alone. Based on the determined condition, an action can be performed.

### BACKGROUND

Home automation networks can control devices and appliances such as lighting, HVAC (heating, ventilation and air conditioning), appliances, security locks of gates and doors and other systems, to provide improved convenience, comfort, energy efficiency and security. Some home automation networks are structured to control a variety of devices from a central control point. The central control point can communicate with devices on the network using any suitable protocol, such as Zigbee, Bluetooth, WiFi and Ethernet.

### BRIEF SUMMARY

According to implementations of the disclosed subject matter, a first input can be received from a first sensor of a home automation network and a second input can be received from a second sensor of the home automation network. A condition can be determined based upon both the first input and the second input. The implementation may not be able determine the condition based on either input alone. Rather, inputs from both sensors may be needed. An implementation may perform an action based on the determined condition.

An implementation may receive a first input from a first sensor of a first home automation network and a second input from a second sensor of a second home automation network. The first and second home networks may be in different homes, or they may be in the same home. The implementation may determine a condition based upon both the first input alone, the second input alone, or both the first and second inputs together. The implementation can perform an action based on the determined condition.

An implementation can include a processor that is configured to receive an input from a first sensor and from a second sensor, determine a condition based on the first and second sensor inputs that may not be able to be determined based on the first or second sensor inputs alone and perform an action based on the determined condition. In an implementation, the processor can be configured to receive inputs from a first sensor in a first home automation network and from a second sensor in a second home automation network. The first and second home automation networks may be co-located in the same home or they may be in different homes. The implementation may determine a condition based on the first or second sensor inputs alone or together and perform an action based on the determined condition.

Systems and techniques according to the present disclosure allow for the determination of a condition based on sensor inputs. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows a method according to an implementation of the disclosed subject matter.

### DETAILED DESCRIPTION

Implementations in accordance with the disclosed subject matter can receive a first input from a first sensor, a second input from a second sensor and, based on the first and second inputs, determine that a condition exists. The existence of the condition may not be determined by the implementation using only the first input from the first sensor or only the second input from the second sensor. Both inputs can be necessary for the implementation to determine the condition. In some implementations, inputs from both sensors are both necessary and sufficient for determining the condition. In other implementations, both inputs are necessary but not sufficient for determining the condition. Additional input from one or more other sources may be necessary to determine the condition.

For example, a chemical sensor in a home automation network can detect pre-combustion natural gas in a house and the implementation can determine that the concentration is above a predetermined safety threshold. Another sensor in the home automation network can determine that a toaster oven is on in the house. The implementation can determine the existence of a fire hazard and send a command to turn the toaster oven off.

As another example, an implementation can detect that a house is empty based on the present locations of the occupant's smartphone and a sensor monitoring an oven determines that it is on. The implementation can determine that the oven has been left on and is unattended and send an alert to the occupant. Likewise, an implementation can prevent the occurrence of false positives. For example, an implementation monitoring a house whose owner is away can detect motion inside the house and also detect that no door or window sensor has been triggered. The implementation can use profile information about the user to determine that the owner has a cat. Rather than automatically sending an alert to the police indicating a possible break-in, the implementation can determine that the detected motion is most likely due to the cat.

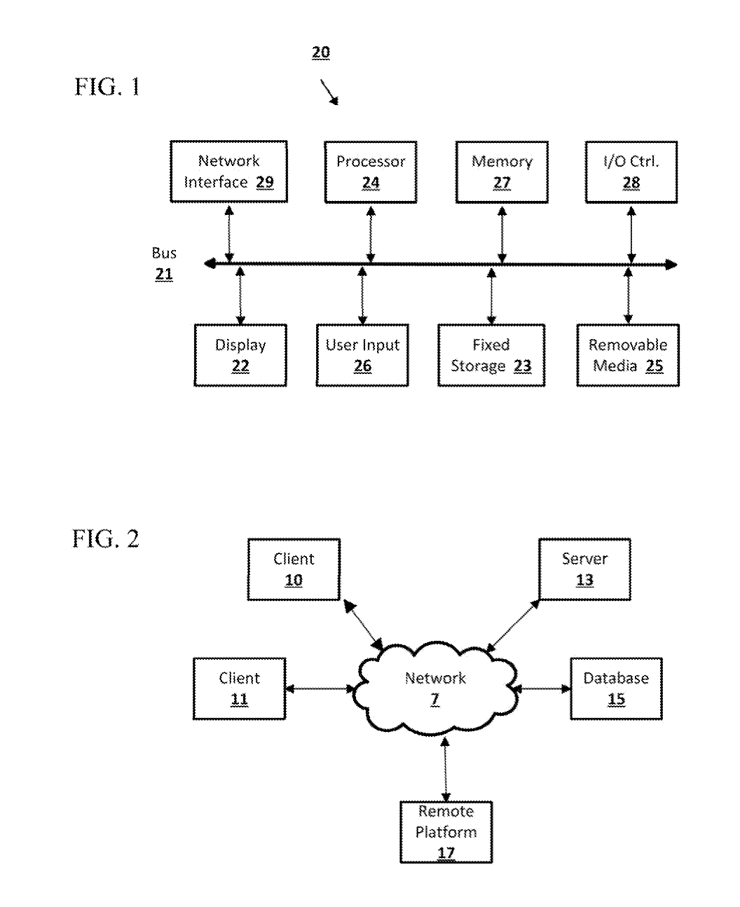

Implementations of the presently disclosed subject matter may be implemented in and used with a variety of component and network architectures. FIG. 1 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

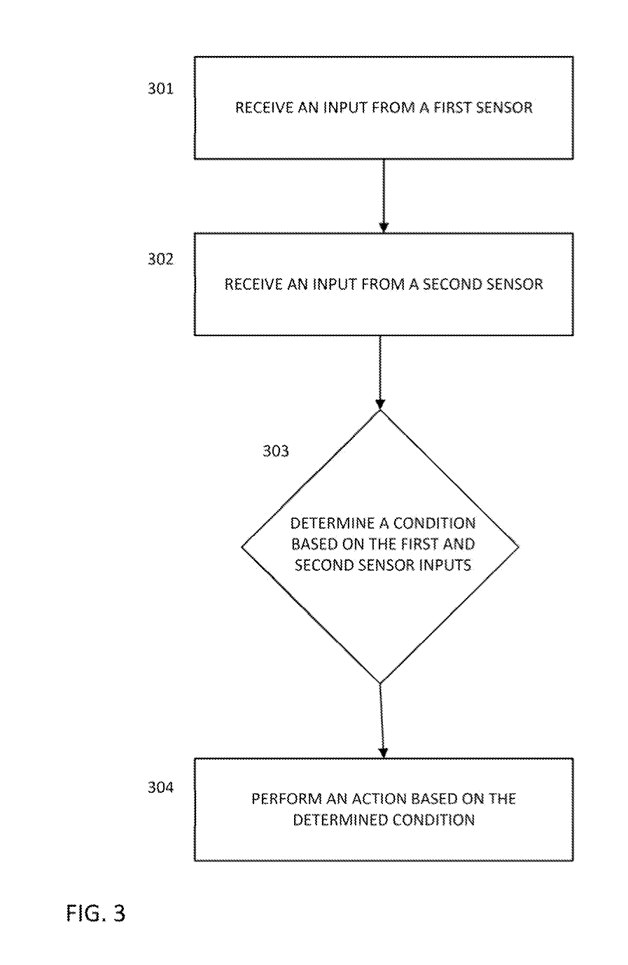

As shown in FIG. 3, an implementation can receive an input from a first sensor 301 and receive a second input from a second sensor 302. The implementation can determine a condition based upon the first and second inputs that cannot be determined from only the first input alone or only the second input alone, 303. Based on the determined condition, the implementation can perform an action.

According to an implementation of the disclosed subject matter, a first input can be received from a first sensor of a home automation network. Examples of sensors include acoustic sensors, sound sensors, vibration sensors, Hall effect sensors, mass flow sensors, speed and acceleration sensors (such as accelerometers), gas sensors (e.g., oxygen, carbon monoxide, natural gas, etc.), radiation sensors (electromagnetic, particle, etc.), pH meter devices, smoke detectors, electrical sensors (e.g., current, voltage, resistance, inductance, capacitance sensors), water detectors, geolocation devices, pressure monitors, force gauges, temperature probes (such as a thermistor or thermocouple), motion detectors and the like.

An implementation of a home automation network in accordance with the disclosed subject matter can include a master controller that is in connection with one or more sensors, appliances (such as ovens, furnaces and refrigerators), devices (such as lights, speakers and thermostats) and other networks, such as the Internet, one or more other home networks and third party networks such as police, fire and rescue networks.

An implementation can also receive a second input from a second sensor of the home automation network. For example, the first input can be from a gas sensor that can detect pre- and post-combustion natural gas. The second input can be from an electrical sensor that can detect when a toaster oven is on or off.

An implementation can determine a condition based upon both the first input and the second input, where the implementation cannot determine the condition based only on the first input without the second input nor based only on the second input without the first input. In the above example, the implementation can determine the existence of a hazardous condition based on a detected elevated level of pre-combustion natural gas combined with an “on” state of the toaster oven. The implementation can perform an action based on this determined condition. For example, the implementation can cause the toaster oven to turn off, shut off the source of natural gas, etc.

In an implementation, a sensor can measure any physical or environmental parameter, such as heat, the presence and/or concentration of at least one gas or type of gas, the presence, intensity, and/or color of light, temperature, sound, radiation, wind and/or other mass flows, the presence of at least one specific liquid or type of liquid, pressure (liquid or gas), force (such as weight).

A sensor can measure a characteristic of any object or thing, such as an appliance (on, off, temperature, power consumption, noise level of an air conditioner, an oven, a furnace, etc.), a utility source (on, off, flow rate, flow volume of electric, gas, water, etc.), a portal (such as the open/close state of a window, a door, a mail slot, garage door and/or a gate), the water level and water condition of a swimming pool, the condition of a roof, a filter (amount filtered, remaining life, etc.) and environmental air (e.g., air quality.)

An implementation can determine a condition based upon profile data. Profile data can include information about a user, about a monitored entity (e.g., anything that is sensed by a sensor), contextual information such as information about the floor plan of a building, historical information and predictive scenarios. For example, profile data can include information about an object such as an appliance, a utility source, a portal, a swimming pool, a fence, a roof, a garage, a filter and an air conditioner. Such information can include information about a manufacturer, model, date of manufacture, date of installation, operating parameter, status and historical performance information about the object. For instance, object information in or associated with a profile can include the dates and times at which an appliance such as an oven was on and off, rates of power consumption, temperatures, cooling times, a repair log describing past faults and repairs to the appliance, etc. A profile for an object can also include information about another object in conjunction with which the object operates, on whose operation the object depends, and/or whose operation affects. For example, a profile for an oven can include information about a gas line or the electrical infrastructure. It could also include information about the operation of a smoke detector, an environmental heating and/or cooling system, a venting system, etc.

Profile data can also include information about a user. Such profile information can include one or more user attributes, such as current and historical physiological information about the user, such as temperature, heart rate, breathing rate, etc. It can also include current and historical data about the user's location, e.g., based upon the determined locations of the user's smartphone or other device. It can also include user preferences (likes and dislikes), account information and other financial information about the user, user logon or other credentials, information from a user calendar and email account, items owned or used by the user, telephone calls made from or to the user, etc.

Profile data can also include predictive data. For example, profile data can include predicted dates and times of faults in appliances and other devices. Such predictive information can be based on statistical failure rates by device or component of device, the particular device history (such as its age, usage, environmental parameters such as temperature, operating temperatures, etc.) Such predictive data can also include predicted environmental characteristics, such as temperature and humidity, based, for example, on weather patterns, thermostat settings, etc. User profile data can also include predictive information, such as the predicted location of a user, e.g., based on historical user locations and patterns, based on the user calendar, etc.

In an implementation, a first threshold can be associated with the first sensor. A condition can be determined when it is determined that the signal from the first sensor has crossed (become less than or greater than or equal to) the threshold and upon a signal received from the second sensor. For example, a dangerous operating condition can be determined when an oven temperature sensor exceeds 600 degrees Fahrenheit and a signal from a second sensor indicates that the oven's self-clean program has not been activated. Likewise, a normal operating condition may be determined when an oven temperature sensor exceeds 600 degrees Fahrenheit and a signal from a second sensor indicates that the oven's self-clean program has been activated.

In an implementation, a second threshold can be associated with a second sensor. A condition can be determined when the first sensor crosses a first threshold and the second sensor crosses the second threshold. For example, a dangerous condition can be determined when a flow sensor reports a bathtub faucet flow rate over one gallon per minute and a location sensor associated with a user reports that the user is more than 500 yards and headed away from the home in which the bathtub is located.

In an implementation, an alert can be received from an outside source. A condition can be determined based on the alert and a sensor input. For example, a high-winds alert can be received from a weather service. A dangerous condition can be determined based upon the received alert and a sensor signal indicating an open window at a home. Likewise, a police alert about a possible intruder in the area can be received. A dangerous condition can be determined based upon the alert and a sensor reporting an unlocked state of a front door.

An alert can also be the result of a user action, such as the user pushing a button, sending a signal to an implementation from a smartphone, a tablet, an embedded computer such as a control system in a car, etc.

In an implementation, a first sensor can correspond to a first home automation network and a second sensor can correspond to a second home automation network. The first and second networks may each be in a different home. Alternatively, the networks may be in the same home. A condition can be determined based upon both the first input and the second input. An action can be performed based on the determined condition.

For example, a first electrical system sensor in a first home network at a first home can indicate a power failure and a second electrical system sensor in a second home network at a second home nearby the first home can indicate no power failure. An implementation can determine a fuse fault in the first home and send an alert to the owner of the first homeowner to reset a fuse in the first home's fuse panel. Alternatively, the first sensor can indicate a power failure in the first home and a second sensor may indicate a power failure in the second home. In that case, an implementation can determined an area power failure and cause the power company to be alerted to the area condition.

When an implementation determines a condition, the implementation can perform an action. One or more actions can correspond to a determined condition. For example, when an oven temperature exceeds a safety threshold, an implementation can determine that a dangerous condition exists and an action can be performed to cut power to the oven. Another action can be to send a notification to a user that the oven has exceeded its safe operating temperature and has been turned off. The action can be selected and performed based on contextual factors. For example, an implementation can determine that the user is near to the oven and send an alert to the user without turning the oven off. The alert can instruct the user to turn off the oven.

Other actions can include turning on or off the flow of water or other fluid, such as natural gas, turning on or off an electrical circuit, sending an alert to a user or to a third party such as the police or a fire department, sending an instruction to a device such as a thermostat, opening or closing a portal such as a window, door or garage, sending an alert or instruction to a different home automation system, making a telephone call, sending a text message, making an entry in a database, executing a software program, etc.

An implementation can determine that a first building (such as a residence or commercial building) has a high concentration of natural gas and that a second, adjacent building also shows high natural gas concentration that may or may not be above a flammability threshold. The implementation may detect a natural gas concentration in a third building that is higher than normal, but is not at a dangerous level. Based on these three observations the implementation determinate that there is a large gas leak that is outside of the first building and alert first responders and the gas company. Additional sensor data (such as wind conditions, input from gas sensors (e.g., installed on smartphones), etc.) can be used by the implementation to more accurately pinpoint the source of the leak with reasonable certainty. Data from user devices such as smartphones can be stripped of Personally Identifiable Data (PID) to protect the privacy of the user.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method, comprising:
receiving a first input from a first sensor of a home automation network;
receiving a second input from a second sensor of the home automation network;
automatically determining a condition based upon both the first input and the second input, wherein the condition cannot be automatically determined based only on the first input without the second input and the condition cannot be automatically determined based only on the second input without the first input; and
performing an action based on the determined condition.

2. The method of claim 1, wherein the first sensor measures at least one from the group consisting of: heat, the presence of at least one gas, the concentration of at least one gas, the presence of light, the intensity of light, the color of light, temperature, sound, radiation, wind, the presence of at least one liquid and pressure.

3. The method of claim 1, wherein the first sensor measures a characteristic of at least one from the group consisting of: an appliance, a utility source, a portal, a swimming pool, a fence, a roof, a garage, a filter and environmental air.

4. The method of claim 1, wherein the determining a condition is further based upon profile data.

5. The method of claim 4, wherein the profile data includes information about the floor plan of a building.

6. The method of claim 4, wherein the profile data includes object information about at least one object from the group consisting of: an appliance, a utility source, a portal, a swimming pool, a fence, a roof, a garage, a filter and an air conditioner.

7. The method of claim 6, wherein object information includes at least one selected from the group of: manufacturer, model, date of manufacture, date of installation, operating parameter and status.

8. The method of claim 6, wherein object information includes historical performance information about the object.

9. The method of claim 4, wherein the profile data includes information about at least one user.

10. The method of claim 9, wherein the profile information about at least one user includes at least one from the group of: a location, user account information, user behavior information and a user attribute.

11. The method of claim 1, further comprising receiving an alert and wherein the determining a condition is further based upon the received alert.

12. The method of claim 1, further comprising associating a first threshold with the first sensor and associating a second threshold with the second sensor and wherein the determining a condition includes determining that the first input exceeds the first threshold and the second input exceeds the second threshold.

13. The method of claim 1, further comprising receiving a first threshold for the first sensor.

14. A method, comprising:
receiving a first input from a first sensor of a first home automation network;
receiving a second input from a second sensor of a second home automation network;
determining a condition based upon both the first input and the second input; and
performing an action based on the determined condition.

15. A system, comprising:
a first sensor;
a second sensor;
a processor in connection with the first sensor and the second sensor, the processor configured to:
receive a first input from the first sensor;
receive a second input from the second sensor;
determine a condition based upon both the first input and the second input, wherein the condition cannot be determined based only on the first input without the second input and the condition cannot be determined based only on the second input without the first input; and
perform an action based on the determined condition.

16. The system of claim 15, wherein the first sensor is configured to measure at least one from the group consisting of: heat, the presence of at least one gas, the concentration of at least one gas, the presence of light, the intensity of light, the color of light, temperature, sound, radiation, wind, the presence of at least one liquid and pressure.

17. The system of claim 15, wherein the first sensor is configured to measure a characteristic of at least one from the group consisting of: an appliance, a utility source, a portal, a swimming pool, a fence, a roof, a garage, a filter and environmental air.

18. The system of claim 15, wherein the processor is further configured to receive profile data and to determine the condition based upon the profile data.

19. The system of claim 18, wherein the profile data includes object information about at least one object from the group consisting of: an appliance, a utility source, a portal, a swimming pool, a fence, a roof, a garage, a filter and an air conditioner.

20. The system of claim 19, wherein object information includes at least one selected from the group of: manufacturer, model, date of manufacture, date of installation, operating parameter and status.

21. The system of claim 19, wherein object information includes historical performance information about the object.

22. The system of claim 18, wherein the profile data includes information about at least one user.

23. The system of claim 22, wherein the profile information about at least one user includes at least one from the group of: a location, user account information, user behavior information and a user attribute.

24. The system of claim 15, further comprising receiving an alert and wherein the determining a condition is further based upon the received alert.

25. The system of claim 15, wherein the processor is further configured to determine that the first input exceeds a first threshold and the second input exceeds a second threshold.

26. The method of claim 1, wherein the processor is further configured to receive a first preset for the first sensor.

27. A system, comprising:
a first sensor;
a second sensor;
a processor in connection with the first sensor and the second sensor, the processor configured to:
receive a first input from the first sensor at a first home network;
receive a second input from the second sensor at a second home network;
determine a condition based upon both the first input and the second input; and
perform an action based on the determined condition.

28. The system of claim 27, wherein the first sensor is configured to measure at least one from the group consisting of: heat, the presence of at least one gas, the concentration of at least one gas, the presence of light, the intensity of light, the color of light, temperature, sound, radiation, wind, the presence of at least one liquid and pressure.

29. The system of claim 27, wherein the first sensor is configured to measure a characteristic of at least one from the group consisting of: an appliance, a utility source, a portal, a swimming pool, a fence, a roof, a garage, a filter and environmental air.

30. The system of claim 27, wherein the processor is further configured to receive profile data and to determine the condition based upon the profile data.

31. The system of claim 30, wherein the profile data includes object information about at least one object from the group consisting of: an appliance, a utility source, a portal, a swimming pool, a fence, a roof, a garage, a filter and an air conditioner.

32. The system of claim 31, wherein object information includes at least one selected from the group of: manufacturer, model, date of manufacture, date of installation, operating parameter and status.

33. The system of claim 31, wherein object information includes historical performance information about the object.
